(19) United States
(12) Patent Application Publication
(10) Pub. No.: US 2011/0210937 A1
(43) Pub. Date: Sep. 1, 2011

(54) Foldable touch screen display apparatus

(75) Inventors: In-seo Kee, Seongnam-si (KR); Hong-shik Shim, Seoul (KR)

(73) Assignee: Samsung Electronics Co., Ltd., Suwon-si (KR)

(21) Appl. No.: 12/926,948

(22) Filed: Dec. 20, 2010

(30) Foreign Application Priority Data
Feb. 26, 2010 (KR) 10-2010-0017922

(51) Int. Cl. G06F 3/045; G06F 3/041; G06F 3/042

(52) U.S. Cl. 345/174; 345/173; 345/176

(57) ABSTRACT

Provided is a foldable touch screen display apparatus. The foldable touch screen display apparatus may include a first display panel, a second display panel at least partially overlapping the first display panel, a transparent plate on at least one of the first and second display panels, a transparent window on the first and second display panels, a first touch panel at a lower part of the transparent window corresponding to the first display panel, and a second touch panel at the lower part of the transparent window corresponding to the second display panel. In example embodiments, the transparent window may be configured to protect the first and second display panels from external shocks and may be foldable as the first and second display panels are folded to each other.

### CROSS-REFERENCE TO RELATED APPLICATIONS

This application claims priority under 35 U.S.C. §119 to Korean Patent Application No. 10-2010-0017922, filed on Feb. 26, 2010, in the Korean Intellectual Property Office (KIPO), the entire contents of which are herein incorporated by reference.

### BACKGROUND

1. Field

Example embodiments relate to a foldable touch screen display apparatus.

2. Description of the Related Art

A foldable display apparatus is convenient to carry about and may provide a relatively wide screen. The foldable display apparatus may be widely applied not only to various mobile equipments, for example, a mobile phone, a portable multimedia player (PMP), a navigator, an ultra mobile PC (UMPC), an electronic book, and an electronic paper, but also to a TV and a computer monitor.

Some conventional display apparatuses are equipped with a touch panel function. In these devices, the display apparatuses have not only a display function but are also capable of performing an input function by contacting a panel surface of the display apparatus with a finger or a dedicated pen.

### SUMMARY

Example embodiments provide a foldable touch screen display apparatus.

Example embodiments will be set forth in part in the description which follows and, in part, will be apparent from the description, or may be learned by practice of example embodiments.

In accordance with example embodiments, a foldable touch screen display apparatus may include a first display panel, a second display panel at least partially overlapping the first display panel, a transparent plate on at least one of the first and second display panels, a transparent window on the first and second display panels, a first touch panel at a lower part of the transparent window corresponding to the first display panel, and a second touch panel at the lower part of the transparent window corresponding to the second display panel. In example embodiments, the transparent window may be configured to protect the first and second display panels from external shocks and may be foldable as the first and second display panels are folded to each other.

In accordance with example embodiments, a foldable touch screen display apparatus may include a first display panel, a second display panel at least partially overlapping the first display panel, a first touch panel at an upper part of the first display panel, a second touch panel at an upper part of the second display panel, a transparent plate on at least one of the first and second touch panels, and a transparent window configured to protect the first and second display panels from external shocks and foldable as the first and second display panels are folded to each other. In example embodiments the transparent window may include first and second hard parts at positions corresponding to the first and second display panels, and a soft part between the first and second hard parts. In example embodiments, the transparent window may be configured to protect the first and second display panels from external shocks and may be foldable as the first and second display panels are folded to each other.

According to example embodiments, a foldable touch screen display apparatus may include a first display panel, a second display panel at least partially overlapping with the first display panel, a transparent plate disposed on at least one of the first and second display panels, a transparent window adapted to protect the first and second display panels from external shocks and foldable as the first and second display panels are folded to each other, a first touch panel disposed at a lower part of the transparent window corresponding to the first display panel, and a second touch panel disposed at the lower part of the transparent window corresponding to the second display panel.

The transparent window may include first and second hard parts disposed at positions corresponding to the first and second display panels, and a soft part disposed between the first and second hard parts.

The first touch panel may be disposed at a lower part of the first hard part, and the second touch panel may be disposed at a lower part of the second hard part.

The first touch panel and the second touch panel may be foldable to each other about the soft part.

The soft part may include any one selected from the group consisting of Teflon, transparent silicon resin, polymethyl methacrylate (PMMA), and polydimethylsiloxane (PDMS).

The first and second hard parts may include any one selected from the group consisting of tempered glass, acrylic and polycarbonate.

Each of the first and second touch panels may include a first transparent electrode layer, a thin film layer, a second transparent electrode layer, and a line electrode.

At least one of the first and second transparent electrode layers may have a surface resistance of not greater than about 400 Ω/sq.

Each of the first and second touch panels may include a transparent electrode layer capable of detecting both an X-axis coordinate value and a Y-axis coordinate value of a touched area.

The first and second touch panels may exchange signals with each other.

In case of a touch across both the first and second touch panels, signals of the touch may be processed without interruption by calculating information such as a track and speed of the touch at a gap between the first and second touch panels from the whole track and speed of the touch on the first and second panels.

Each of the first and second touch panels may include a line electrode disposed on at least one side surface thereof, but except on a side surface disposed between the first and second touch panels.

The first and second touch panels may include any one of a resistive film type touch panel, a capacitive type touch panel, an infrared type touch panel, and an ultrasonic type touch panel.

Each of the first and second display panels may include a substrate, a display device disposed on an upper part of the substrate, and a protection cover adapted to cover the display device at the upper part of the substrate.

The display device may include any one selected from a liquid crystal display (LCD), a field emission display (FED), a plasma display panel (PDP), a light-emitting diode (LED), and an organic LED (OLED).

The transparent plate may be disposed on an upper part of the second display panel to enclose a lower surface, an upper surface, and a side surface of the first display panel, wherein the side surface may be between the first and second display panels.

The transparent plate may be disposed on an upper part of the second display panel to contact a side surface and a part of an upper surface of the first display panel and to extend between the first and second touch panels.

Any one of a polarizing film, an anti-reflection (AR) film, or an anti-glare (AG) film may be attached to the entire surface of the transparent plate.

According to example embodiments, a foldable touch screen display apparatus may include a first display panel, a second display panel at least partially overlapping with the first display panel, a first touch panel disposed at an upper part of the first display panel, a second touch panel disposed at an upper part of the second display panel, a transparent plate disposed on at least one of the first and second touch panels, and a transparent window adapted to protect the first and second display panels from external shocks and foldable as the first and second display panels are folded to each other, wherein the transparent window includes first and second hard parts disposed at positions corresponding to the first and second display panels, and a soft part disposed between the first and second hard parts.

Each of the first and second display panels may include a substrate, a display device disposed on an upper part of the substrate, and a protection cover adapted to cover the display device at the upper part of the substrate, and the first touch panel may be disposed at a region of the first display panel corresponding to a corresponding display device, and the second touch panel may be disposed at a region of the second display panel corresponding to a corresponding display device.

Each of the first and second touch panels may include a line electrode disposed on at least one side surface thereof, but except on a side surface disposed between the first and second touch panels.

The first and second touch panels may be arranged to look continuous as seen from above the transparent window.

### BRIEF DESCRIPTION OF THE DRAWINGS

Example embodiments will become apparent and more readily appreciated from the following description, taken in conjunction with the accompanying drawings of which:

FIG. 1 is a perspective view showing a foldable touch screen display apparatus according to example embodiments;

FIG. 2 is a sectional view schematically showing the foldable touch screen display apparatus;

FIG. 3 is a cross-sectional view of first and second touch panels of the foldable touch screen display apparatus, according to example embodiments;

FIG. 4 is a schematic cross-sectional view of the first and second touch panels of the foldable touch screen display apparatus, according to example embodiments;

FIG. 5 is a plan view schematically showing the first and second touch panels of the foldable touch screen display apparatus;

FIGS. 6 and 7 respectively are a perspective view and a sectional view showing the foldable touch screen display apparatus in a folded state;

FIG. 8 is a sectional view schematically showing a foldable touch screen display apparatus according to example embodiments;

FIG. 9 is a sectional view schematically showing a foldable touch screen display apparatus according to example embodiments; and

FIG. 10 is a sectional view schematically showing a foldable touch screen display apparatus according to example embodiments.

### DETAILED DESCRIPTION

Example embodiments will now be described more fully with reference to the accompanying drawings in which example embodiments are shown.

Example embodiments are disclosed herein. However, specific structural and functional details disclosed herein are merely representative for purposes of describing example embodiments. Example embodiments, however, may be embodied in many alternate forms and should not be construed as limited to only example embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items.

It will be understood that when an element or layer is referred to as being “formed on,” another element or layer, it can be directly or indirectly formed on the other element or layer. That is, for example, intervening elements or layers may be present. In contrast, when an element or layer is referred to as being “directly formed on,” to another element, there are no intervening elements or layers present. Other words used to describe the relationship between elements or layers should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

In the drawings, the thicknesses of layers and regions are exaggerated for clarity. Like reference numerals in the drawings denote like elements.

Hereinafter, a foldable touch screen display apparatus will be described in detail with reference to the accompanying drawings. In the drawings, the width and thickness of each of the elements such as layers and regions may be exaggerated for clarity of illustration. Also, the same reference numerals refer to the same elements throughout the specification.

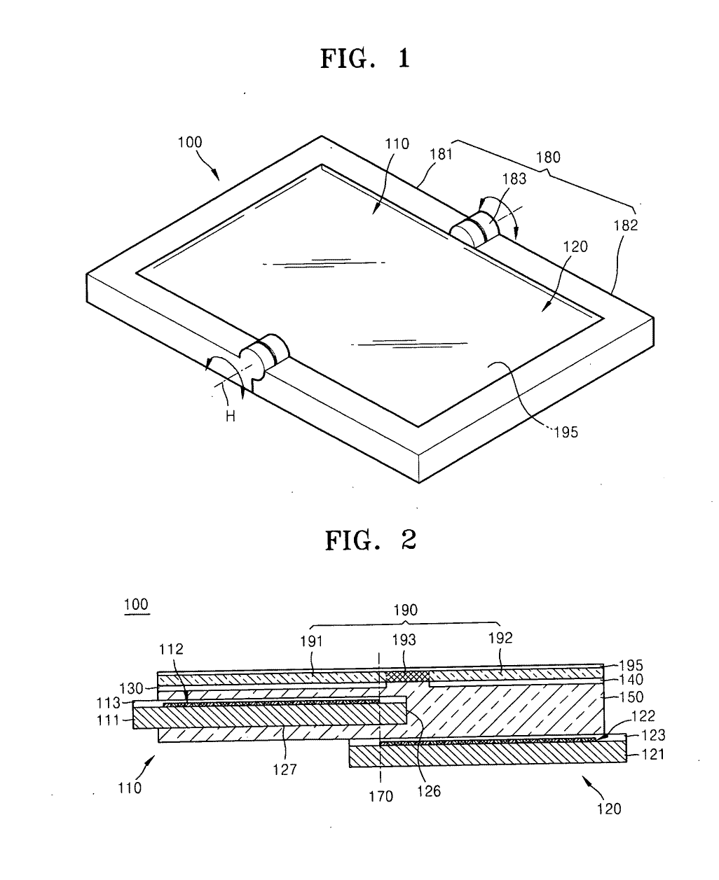

FIGS. 1 and 2 show a foldable touch screen display apparatus 100 according to example embodiments. The foldable touch screen display apparatus 100 may be constructed by connecting a plurality of display panels and touch panels in various methods. In example embodiments, the foldable touch screen display apparatus 100 may be constructed by connecting first and second display panels 110 and 120 to each other and connecting first and second touch panels 130 and 140 to each other. First and second display devices 112 and 122 for forming images are briefly shown in the drawings.

Although FIGS. 1 and 2 show an example where two display panels, namely, the first and second display panels 110 and 120 and two touch panels, namely, the first and second touch panels 130 and 140, are connected, the same principle may be applied when three or more display panels and touch panels constitute one screen.

The foldable touch screen display apparatus 100 may include a main body 180 divided into a first body 181, a second body 182, and a hinge portion 183 connecting the first body 181 to the second body 182. A hinge axis H may extend through the center of the hinge portion 183. As shown in FIG. 2, the first and second display panels 110 and 120 may include the first and second display devices 112 and 122 deposited on first and the second substrates 111 and 121 to form images, and first and second protection covers 113 and 123 covering and protecting the first and second display devices 112 and 122, respectively. Therefore, when the foldable touch screen display apparatus 100 is a top emission type, images formed by the first and second display devices 112 and 122 may be displayed through the first and second protection covers 113 and 123 of the first and second display panels 110 and 120, respectively. On the other hand, when the foldable touch screen display apparatus 100 is a bottom emission type, the images are displayed through the first and second substrates 111 and 121. FIGS. 1 and 2 show an example of the top emission type. In example embodiments, the first and second display devices 112 and 122 that may be respectively included in the first and second display panels 110 and 120 may be flat panel display devices including a liquid crystal display (LCD), a field emission display (FED), a plasma display panel (PDP), a light-emitting diode (LED), and an organic LED (OLED).

The first and second display panels 110 and 120 may be static or, as shown in FIG. 1, may be connected in a foldable structure. According to the foldable structure, the first and second display panels 110 and 120 may constitute one screen and may be folded and unfolded about the hinge axis H. In example embodiments, the first and second display panels 110 and 120 of the foldable touch screen display apparatus 100 may be unfolded and the first and second display panels 110 and 120 may be unfolded so as to partially overlap each other at upper and lower positions in a stepwise manner. In example embodiments, the first and second display panels 110 and 120 may overlap and interfacing surfaces of the first and second display devices 112 and 122 may be aligned on a vertical line 170, accordingly, the whole screen of the foldable touch screen display apparatus 100 may look continuous when seen from above.

Even in this state, however, a stepwise discontinuity in a vertical direction may still exist between the first and second display panels 110 and 120. To lessen or minimize the stepwise discontinuity, the foldable touch screen display apparatus 100 may be provided with a transparent plate 150 disposed at an upper part of the second display panel 120 to cover an upper part of the first display panel 110. The transparent plate 150 may be configured to cover one side surface 126 and a lower surface 127 of the first display panel 110.

Although FIG. 2 shows the transparent plate 150 covering an upper surface of the first display panel 110, according to example embodiments, the transparent plate 150 may have the same height as the first display panel 110. Also, the foldable touch screen display apparatus 100 may further include a transparent window 190 disposed at the upper parts of the first and second display panels 110 and 120. The transparent window 190 may be adapted to protect the first and second display panels 110 and 120, and the transparent plate 150 from external shocks. In example embodiments, the transparent window 190 may be configured to fix the first and second touch panels 130 and 140.

The transparent window 190 according to example embodiments may include first and second hard parts 191 and 192. In example embodiments, the first and second hard parts 191 and 192 may be configured to protect the first and second display panels 110 and 120, the first and second touch panels 130 and 140, and the transparent plate 150 from external shocks. In addition, a soft part 193, which may be transparent, may be disposed between the first and second hard parts 191 and 192. In example embodiments, the soft part 193 may correspond to the hinge axis H1 and may be configured to enable a folding motion of the first and second display panels 110 and 120.

The first and second touch panels 130 and 140 may be disposed at a lower part of the transparent window 190 in regions corresponding to the first and second display panels 110 and 120, respectively. For example, as shown in FIG. 2, the first and second touch panels 130 and 140 may be disposed at lower parts of the first and second hard parts 191 and 192, respectively, so that the first and second touch panels 130 and 140 may be foldable towards each other about the soft part 193. The first and second touch panels 130 and 140 may adopt any one of resistive film type, capacitive type, infrared type, and ultrasonic type touch panels.

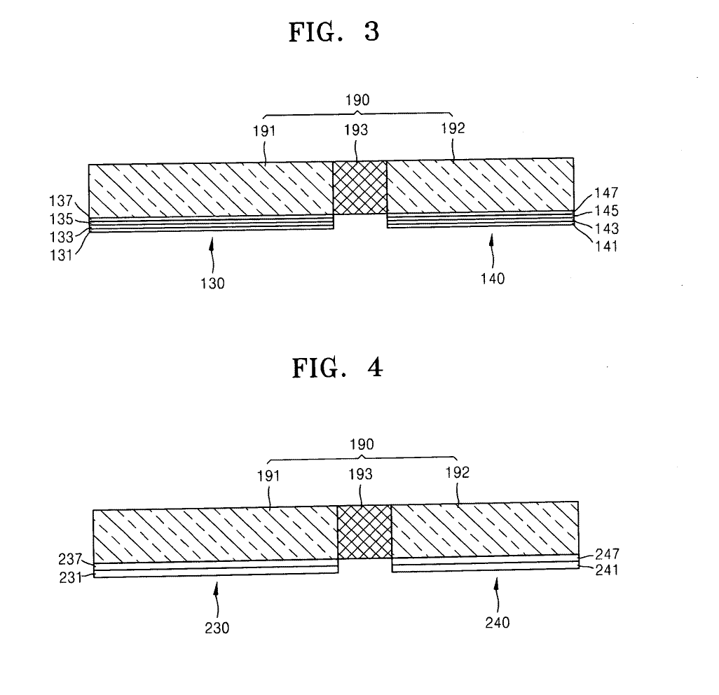

FIG. 3 is a cross-sectional view of the first and second touch panels 130 and 140 of the foldable touch screen display apparatus 100, according to example embodiments. In example embodiments, the first and second touch panels 130 and 140 may be the capacitive type touch panels. In a resistive film type touch panel of a related art, a short circuit may occur as the touch panel is folded because a gap between upper and lower substrates is narrowed by the folding motion. To this end, a spacer has been used in the resistive film type touch panel to prevent the short circuit. However, capacitive type touch panels do not have such limitations. Furthermore, it is relatively difficult to lessen the effects of external shocks to resistive film type touch panels because the resistive film type touch panels are disposed on a protective transparent window. However, the capacitive type touch panels may effectively be protected from external shocks because the touch panel is disposed under a transparent window.

Referring to FIG. 3, the first and second touch panels 130 and 140 may include laminated structures respectively including first transparent electrode layers 131 and 141, thin film layers 133 and 143, and second transparent electrode layers 135 and 145. Although not shown in FIG. 3, the first and second touch panels 130 and 140 may each further include a line electrode. The first and second touch panels 130 and 140 may have a thin film form to be attached to the lower part of the transparent window 190 through a medium of adhesive layers 137 and 147. FIG. 3 shows an example where the first and second touch panels 130 and 140 are attached to lower parts of the first and second hard parts 191 and 192 of the transparent window 190 through the medium of the adhesive layers 137 and 147, respectively. Here, the thin film layers 133 and 143 may be made of an insulating material. The first and second touch panels 130 and 140 may be disposed at the lower parts of the first and second hard parts 191 and 192, respectively. That is, the first and second touch panels 130 and 140 may be arranged at the lower part of the transparent window 190 with an interval there between. According to this configuration, the first and second touch panels 130 and 140 are foldable about the soft part 193 formed between the first and second hard parts 191 and 192.

The first and second transparent electrode layers 131, 141, 135, and 145 may be formed by thin film vapor deposition at the lower part of the transparent window 190. More specifically, the second transparent electrode layers 135 and 145 may be formed by vapor deposition and patterning at the lower part of the transparent window 190 during thin-film vapor deposition. An insulating material may be vapor-deposited on the second transparent electrode layers 135 and 145, thereby forming the thin film layers 133 and 143. The first transparent electrode layers 131 and 141 may be formed on the thin film layers 133 and 143 by vapor deposition and patterning. An insulating layer may be formed additionally on the first and second transparent electrode layers 131, 141, 135, and 145 by vapor deposition to protect the first and second transparent electrode layers 131, 141, 135, and 145.

When a single touch panel using an Indium Tin Oxide (ITO) electrode layer is folded, cracks may occur in the ITO electrode layer and electrical conductivity of the (ITO) electrode layer may accordingly deteriorate. To this end, a conductive high-molecular electrode layer may be used at a folding part. However, because the conductive high-molecular electrode layer may have a surface resistance of about 2000 Ω/sq to about 5000 Ω/sq, which is higher than that of the ITO electrode layer, a signal may be slowly transmitted and the increase in screen area of the touch screen display may be restricted. Furthermore, because the conductive high-molecular electrode layer may have a lower optical transmittance than the ITO electrode layer, images may be displayed in the wrong color or look darker than their originals. However, when the foldable touch screen is constituted by two touch panels, that is, the first and second touch panels 130 and 140, such problems may be reduced or minimized.

The first and second transparent electrode layers 131, 141, 135, and 145 may include ITO and carbon nanotubes (CNT), however, example embodiments are not limited thereto. At least one of the first and second transparent electrode layers 131, 141, 135, and 145 may have a surface resistance of not greater than about 400 Ω/sq. Such a low surface resistance of the first and second transparent electrode layers 131, 141, 135, and 145 may be effective to transmit a relatively fast signal and provide a relatively large area screen of the touch screen display apparatus 100. Also, the surface resistance may not increase even if the touch screen display is folded a large number of times. At least one of the first and second transparent electrode layers 131, 141, 135, and 145 may have an optical transmittance of not less than about 85%. Such a high optical transmittance of the first and second transparent electrode layers 131, 141, 135, and 145 may be effective to prevent or reduce a change of the original color of images being displayed and brightness deterioration. The line electrode may include metal such as Au, Ag, and Cu. The first transparent electrode layers 131 and 141 may detect an X-axis coordinate value of a touch and the second transparent electrode layers 135 and 145 may detect a Y-axis coordinate value of the touch. However, example embodiments are not limited thereto, for example, the first transparent electrode layers 131 and 141 may detect a Y-axis coordinate value of a touch while the second transparent electrode layers 135 and 145 may detect an X-axis coordinate value of the touch.

FIG. 4 is a schematic cross-sectional view of the first and second touch panels 230 and 240 of the foldable touch screen display apparatus 100, according to example embodiments.

Referring to FIG. 4, first and second touch panels 230 and 240 may be in the form of single transparent electrode layers 231 and 241, respectively. Although not shown in FIG. 4, the first and second touch panels 230 and 240 may each further include a line electrode. The first and second touch panels 230 and 240 may be attached to the lower part of the transparent window 190 through a medium of adhesive layers 237 and 247. In example embodiments, the transparent electrode layers 231 and 241 may perform all functions of the first and second transparent electrode layers 131, 141, 135, and 145. In other words, the transparent electrode layers 231 and 241 may be capable of detecting both X-axis and Y-axis coordinate values of a touch. The transparent electrode layers 231 and 241 may have an optical transmittance of about 95% or more, which may be an improvement in comparison with that of the first and second transparent electrode layers 131, 141, 135, and 145. In addition, when one transparent electrode layer is used instead of two transparent electrode layers, the first and second touch panels 230 and 240 may be manufactured in a thickness of about 5 an or less. Moreover, when the transparent electrode layers 231 and 241 are integrally formed with the transparent window 190, the number of manufacturing process and the manufacturing cost of the first and second touch panels 230 and 240 may be reduced or minimized.

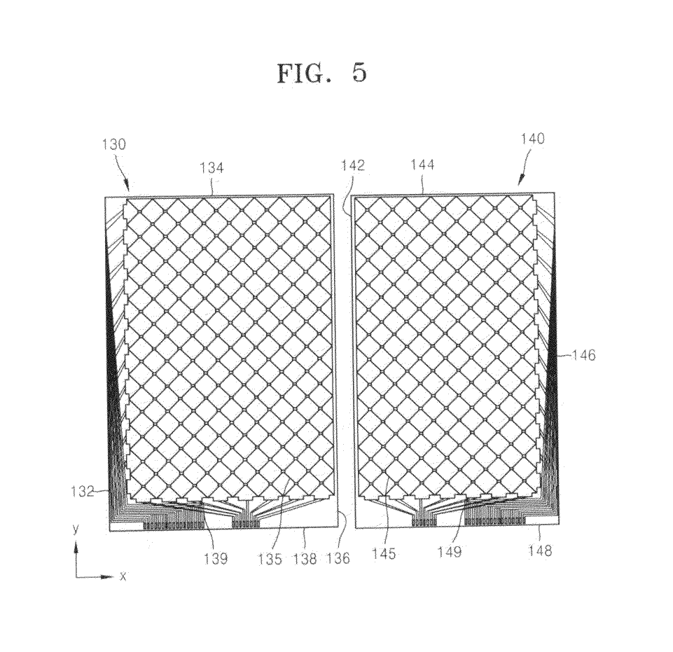

FIG. 5 is a plan view showing the first and second touch panels 130 and 140 of the foldable touch screen display apparatus 100. As shown in FIG. 5, the second transparent electrode layers 135 and 145 may have a diamond-type lattice structure. A line electrode 139 may be formed at first and fourth side surfaces 132 and 138 of the first touch panel 130. Although not shown, the first transparent electrode layers 131 and 141 may also have a diamond-type lattice structure that is disposed at the lower parts of the second transparent electrode layers 135 and 145. However, this is only an example and the first and second transparent electrode layers 131, 141, 135, and 145 may have different arrangement structures. The line electrode 139 of the first touch panel 130 may be provided to any one of first, second, and fourth side surfaces 132, 134, and 138 of the first touch panel 130, and not a third side surface 136 of the first touch panel 130. FIG. 5 also shows a line electrode 149 formed at third and fourth side surfaces 146 and 148 of the second touch panel 140. The line electrode 149 of the second touch panel 140 may be provided to any one of second, third and fourth side surfaces 144, 146 and 148 of the second touch panel 140, and not a first side surface 142 of the second touch panel 140. That is, the line electrodes 139 and 149 may not be provided between the first and second touch panels 130 and 140. As a result, a distance between the first and second touch panels 130 and 140 may be minimized or reduced while providing a relatively reliable folding motion of the first and second touch panels 130 and 140. Here, the distance between the first and second touch panels 130 and 140 may be about 2 min to about 4 mm.

The first and second touch panels 130 and 140 may exchange signals with each other through an interface circuit such that a touch screen may operate through both of the first and second display panels 110 and 120, that is, through the entire display screen. Accordingly, the signals of the first and second touch panels may be connected with each other. In other words, since the signals may be exchangeable between the first and second touch panels 130 and 140, a touch may be detectable on the entire display screen. Although a gap may exist between the first and second touch panels 130 and 140, the gap may be so narrow that a finger touch will not be missed. However, in case of a touch across both the first and second touch panels 130 and 140, a dedicated algorithm may be used in order to recognize the touch separately detected by the first and second touch panels 130 and 140 as one continuous touch. That is, the touch across both of the first and second touch panels 130 and 140 may be recognized as one continuous touch by the algorithm. The algorithm may recognize signals detected by the first and second touch panels 130 and 140 regarding the touch across both of the first and second touch panels 130 and 140, and may then calculate information such as a track and speed of the touch at a position between the first and second touch panels 130 and 140 by using the whole track and speed of the touch. Thus, the signals of the touch across both the first and second touch panels 130 and 140 may be processed without interruption by using the information. Non-limiting examples of the touch across both the first and second touch panels 130 and 140 may include sliding, scrolling, and page turning.

The transparent plate 150 may be made of a soft material, which may be flexibly folded and resiliently restored, so as to perform the folding motion of the first and second display panels 110 and 120 and the first and second touch panels 130 and 140. For example, the transparent plate 150 may include any one selected from the group consisting of polymethyl methacrylate (PMMA), polydimethylsiloxane (PDMS), transparent silicon resin, and Teflon (polytetrafluoroethylene, PTFE). An additive may be contained in these materials to control a refractive index of the transparent plate 150. The soft part 193 of the transparent window 190 may be formed of a flexible and resilient high-molecular material. For example, the soft part 193 may include any one selected from the group consisting of PMMA, PDMS, transparent silicon resin, and Teflon. The first and second hard parts 191 and 192 being in the form of a transparent plate may be made of transparent plastic, for example, an acrylic and/or polycarbonate, or tempered glass.

The thickness of the transparent plate 150 may vary according to the thickness of the first display panel 110. The first display panel 110 may have a thickness of about 0.01 mm to about 3 mm. The transparent plate 150 may be about 0.002 mm to about 2 mm thicker than the first display panel 110. To be more specific, a part of the transparent plate 150 enclosing the first display panel 110 may have a thickness of about 0.001 mm to about 1 mm from an upper surface or a lower surface of the first display panel 110. A part of the transparent plate 150 extended toward an upper surface of the second display panel 120 may have a thickness of about 0.012 mm to about 5 mm. The first protection cover 113 and the transparent plate 150 may have substantially the same refractive index so that light is minimally or not refracted at an interface between the first protection cover 113 of the first display panel 110 and the transparent plate 150. The refractive index of the first protection cover 113 and the transparent plate 150 may be substantially the same as long as light is not refracted at the interface between the first protection cover 113 of the first display panel 110 and the transparent plate 150. For this, the refractive index of the transparent plate 150 may be in the range of about 1.3 to about 1.7.

In example embodiments, an optical film 195 may be further attached to an upper part of the transparent plate 150. For example, a polarizing film, an anti-reflection (AR) film, or an anti-glare (AG) film may be attached to the entire surface of the transparent plate 150.

The transparent window 190 may have a thickness of about 0.002 mm to 2 mm. The first and second touch panels 130 and 140 may have a thickness of about 0.1 mm or less.

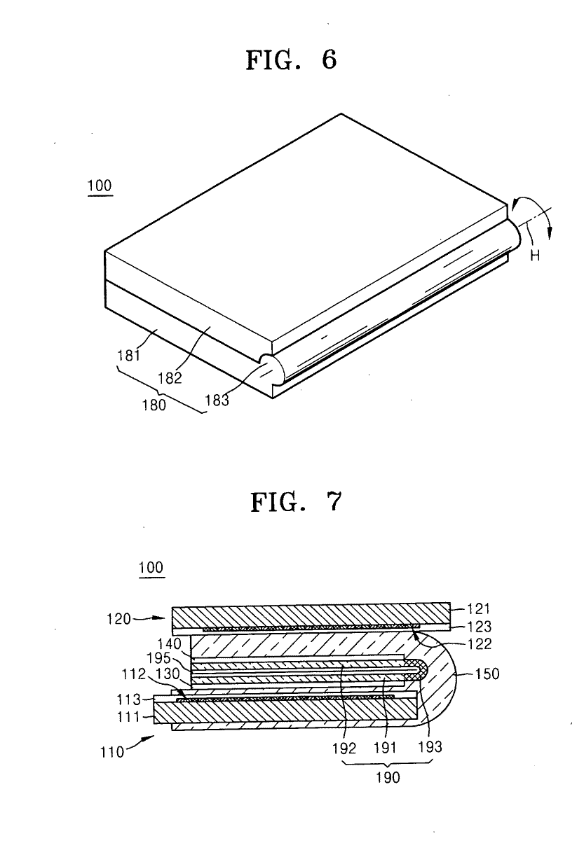

FIG. 6 and FIG. 7 respectively are a perspective and a sectional view showing the foldable touch screen display apparatus 100 of FIGS. 1 and 2 in a folded state. The first and second display panels 110 and 120, the first and second touch panels 130 and 140, and the transparent window 190 are not shown in FIG. 6 because these parts are disposed inside the folded main body 180.

Referring to FIG. 7, the soft part 193 of the transparent window 190 may be disposed corresponding to the hinge axis H1. The transparent plate 150 made of a flexible material may be easily folded according to the folding of the first and second display panels 110 and 120 and the first and second touch panels 130 and 140. Although the thickness of the transparent window 190 and the transparent plate 150 are exaggerated in FIG. 7, the transparent window 190 and the transparent plate 150 may be thin enough to be easily folded.

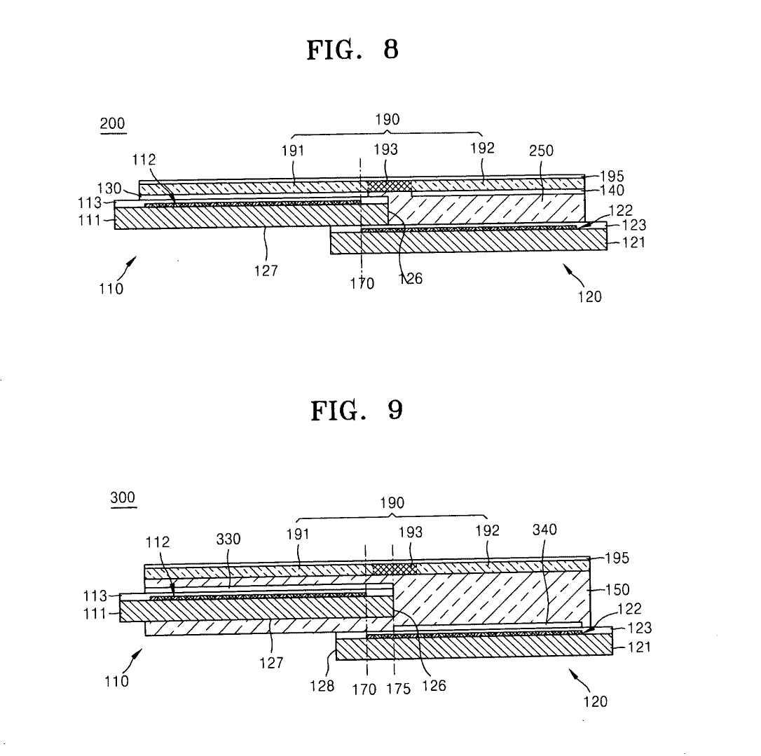

FIG. 8 is a sectional view schematically showing a foldable touch screen display apparatus 200 according to example embodiments. The same elements as explained with reference to FIGS. 1 through 7 will be cited by the same reference numerals, and thus, a detailed description thereof will be omitted.

Referring to FIG. 8, the first substrate 111 of the first display panel 110 may partially overlap with the second display panel 120. A transparent plate 250 may be disposed at the upper part of the second display panel 120 to have the same height as the upper surface of the first display panel 110, and may contact the side surface 126 of the first display panel 110. The transparent plate 250 may also be formed between the first and second touch panels 130 and 140 formed at the lower part of the transparent window 190, that is, at the lower part of the soft part 193. The transparent plate 250 may be disposed on the upper part of the second display panel 120 and may contact the side surface 126 and a part of the upper surface of the first display panel 110 and may extend between the first and second touch panels 130 and 140, as shown in FIG. 8.

Since the first and second display panels 110 and 120 are arranged to closely contact each other at an interface between them, a vertical gap between a light emitting region of the first display panel 110 and a light emitting region of the second display panel 120 may be reduced, compared to in the foldable touch screen display apparatus 100 of FIG. 2. Consequently, the stepwise discontinuity between the first and second display panels 110 and 120 may be reduced. Since the structure and operation of the foldable touch screen display apparatus 200 shown in FIG. 8 are the same as those of the foldable touch screen display apparatus 100 shown in FIG. 2, a detailed description thereof will be omitted.

FIG. 9 is a schematic sectional view showing a foldable touch screen display apparatus 300 according to example embodiments. The same elements as in the foldable touch screen display apparatuses 100 and 200 introduced in FIGS. 1 to 7 will be cited by the same reference numerals, and thus, a detailed description thereof will be omitted.

Referring to FIG. 9, differently from the foldable touch screen display apparatus 100 shown in FIG. 2, first and second touch panels 330 and 340 may be respectively disposed at the upper parts of the first and second display panels 110 and 120. The first and second touch panels 330 and 340 may be folded together with the first and second display panels 110 and 120 about the soft part 193 of the transparent window 190. A line electrode may not be provided between the first and second touch panels 330 and 340. Therefore, when interfacing surfaces of the first and second touch panels 330 and 340 are aligned on a vertical line 175, the whole screen of the foldable touch screen display apparatus 300 may look continuous when seen from above. Although FIG. 9 shows the vertical line 175 disposed corresponding to the side surface 126 of the first display panel 110, the vertical line 175 may be disposed between a side surface 128 of the second display panel 120 and the side surface 126 of the first display panel 110. In example embodiments, the interfacing surfaces of the first and second touch panels 330 and 340 may be aligned on the vertical line 175. Accordingly, the first and second touch panels 330 and 340 may be arranged to look continuous when seen from above the transparent window 190. In example embodiments, a dedicated algorithm for calculating information regarding the touch across both the first and second touch panels 330 and 340 may not be used, which is a difference from the foldable touch screen display apparatus 100 of FIG. 2. However, considering that the second touch panel 340 may be disposed farther from a touch surface than the first touch panel 330, the second touch panel 340 may be designed to more sensitively detect a touch than the first touch panel 330. For example, when capacitive type touch panels are used, the second touch panel 340 may more sensitively detect change in capacitance by a touch than the first touch panel 330.

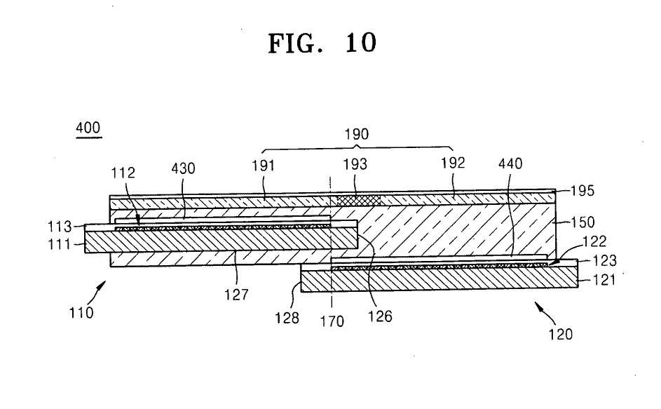

FIG. 10 is a sectional view schematically showing a foldable touch screen display apparatus 400 according to example embodiments. The same elements as explained with reference to FIGS. 1 through 7 will be cited by the same reference numerals, and thus, a detailed description thereof will be omitted.

Referring to FIG. 10, differently from the foldable touch screen display apparatus 100 shown in FIG. 2, first and the second touch panels 430 and 440 may be disposed on the first and second display panels 110 and 120 to correspond to the first and second display devices 112 and 122, respectively. The first and second touch panels 430 and 440 may be folded along with the first and second display panels 110 and 120, respectively, about the soft part 193 of the transparent window 190. A line electrode may not be provided between the first and second touch panels 430 and 440. Therefore, the whole screen of the foldable touch screen display apparatus 400 may look continuous as seen from above the transparent window 190 when the first and second touch panels 430 and 440 are aligned on the vertical line 170, differently from in the foldable touch screen display apparatus 300 of FIG. 9 where the first and second touch panels 330 and 340 may be aligned on the vertical line 175 which may correspond to the side surface 126 of the first display panel 126. In other words, not only the first and second display panels 110 and 120 but also the first and second touch panels 430 and 440 may look continuous as seen from above the transparent window 190. In example embodiments, a dedicated algorithm for calculating information regarding the touch across both the first and second touch panels 430 and 440 may not be used, differently from in the foldable touch screen display apparatus 100 shown in FIG. 2. However, considering that the second touch panel 440 may be disposed farther from a touch surface than the first touch panel 430, the second touch panel 440 may be designed to more sensitively detect a touch than the first touch panel 440. For example, when capacitive type touch panels are used, the second touch panel 440 may more sensitively detect change of capacitance by a touch than the first touch panel 430.

Although example embodiments of foldable touch screen display apparatuses have been explained with reference to the drawings, it should be understood that example embodiments described therein should be considered in a descriptive sense only and not for purposes of limitation. Descriptions of features or aspects within example embodiments should typically be considered as available for other similar features or aspects in other embodiments.

What is claimed is:

1. A foldable touch screen display apparatus comprising:
a first display panel;
a second display panel at least partially overlapping the first display panel;
a transparent plate on at least one of the first and second display panels;
a transparent window on the first and second display panels, the transparent window configured to protect the first and second display panels from external shocks and foldable as the first and second display panels are folded to each other;
a first touch panel at a lower part of the transparent window corresponding to the first display panel; and
a second touch panel at the lower part of the transparent window corresponding to the second display panel.

2. The foldable touch screen display apparatus of claim 1, wherein the transparent window comprises:
first and second hard parts at positions corresponding to the first and second display panels; and
a soft part between the first and second hard parts.

3. The foldable touch screen display apparatus of claim 2, wherein the first touch panel is at a lower part of the first hard part, and the second touch panel is at a lower part of the second hard part.

4. The foldable touch screen display apparatus of claim 2, wherein the first touch panel and the second touch panel are foldable to each other about the soft part.

5. The foldable touch screen display apparatus of claim 2, wherein the soft part comprises any one selected from the group consisting of Teflon, transparent silicon resin, polymethyl methacrylate (PMMA), and polydimethylsiloxane (PDMS).

6. The foldable touch screen display apparatus of claim 2, wherein the first and second hard parts comprise any one selected from the group consisting of tempered glass, acrylic and polycarbonate.

7. The foldable touch screen display apparatus of claim 1, wherein each of the first and second touch panels comprises a first transparent electrode layer, a thin film layer, a second transparent electrode layer, and a line electrode.

8. The foldable touch screen display apparatus of claim 1, wherein each of the first and second touch panels includes a transparent electrode layer configured to at least one of detect an X-axis coordinate value and a Y-axis coordinate value of a touched area.

9. The foldable touch screen display apparatus of claim 1, wherein signals may be exchanged between the first and second touch panels.

10. The foldable touch screen display apparatus of claim 1, wherein, in case of a touch across both the first and second touch panels, signals of the touch are processed without interruption by calculating information for at least one of a track and speed of the touch at a gap between the first and second touch panels from the whole track and speed of the touch on the first and second panels.

11. The foldable touch screen display apparatus of claim 1, wherein each of the first and second touch panels includes at least one side surface connected to a line electrode and a side surface not connected to the line electrode, the side surface not connected to the line electrode being arranged between the first and second touch panels.

12. The foldable touch screen display apparatus of claim 1, wherein the first and second touch panels includes one of a resistive film type touch panel, a capacitive type touch panel, an infrared type touch panel, and an ultrasonic type touch panel.

13. The foldable touch screen display apparatus of claim 1, wherein each of the first and second display panels includes a substrate, a display device on an upper part of the substrate, and a protection cover on the display device.

14. The foldable touch screen display apparatus of claim 13, wherein the display device includes one of a liquid crystal display (LCD), a field emission display (FED), a plasma display panel (PDP), a light-emitting diode (LED), and an organic LED (OLED).

15. The foldable touch screen display apparatus of claim 1, wherein the transparent plate is on an upper part of the second display panel and encloses a lower surface, an upper surface, and a side surface of the first display panel, the side surface being between the lower surface and the upper surface.

16. The foldable touch screen display apparatus of claim 1, wherein the transparent plate is on an upper part of the second display panel and is configured to contact a side surface and a part of an upper surface of the first display panel and to extend between the first and second touch panels.

17. A foldable touch screen display apparatus comprising:
a first display panel;
a second display panel at least partially overlapping the first display panel;
a first touch panel at an upper part of the first display panel;
a second touch panel at an upper part of the second display panel;
a transparent plate on at least one of the first and second touch panels; and
a transparent window on the first and second display panels, the transparent window being configured to protect the first and second display panels from external shocks and foldable as the first and second display panels are folded to each other,
wherein the transparent window includes first and second hard parts at positions corresponding to the first and second display panels, and a soft part between the first and second hard parts.

18. The foldable touch screen display apparatus of claim 17, wherein
each of the first and second display panels includes a substrate, a display device on an upper part of the substrate, and a protection cover configured to cover the display device, and
the first touch panel is at a region corresponding to the display device of the first display panel, and the second touch panel is at a region corresponding to the display device of the second display panel.

19. The foldable touch screen display apparatus of claim 17, wherein each of the first and second touch panels includes at least one side surface connected to a line electrode and a side surface not connected to the line electrode, the side surface not connected to the line electrode being arranged between the first and second touch panels.

20. The foldable touch screen display apparatus of claim 17, wherein the first and second touch panels are arranged to look continuous as seen from above the transparent window.
